(19) United States
(12) Patent Application Publication
(10) Pub. No.: US 2025/0024817 A1
(43) Pub. Date: Jan. 23, 2025

(54) Egg Laying Box

(71) Applicant: Dezhou Weiqian Import and Export Co., LTD, Dezhou (CN)

(72) Inventor: Dehua Meng, Dezhou (CN)

(21) Appl. No.: 18/223,379

(22) Filed: Jul. 18, 2023

(51) Int. Cl. A01K 31/16

(52) U.S. Cl. CPC A01K 31/16

(57) ABSTRACT

An egg laying box relates to the technical field of culture tools. The egg laying box includes a box body, and at least one egg laying cavity is disposed on the box body. The box body includes: a center wall panel, a top cover, and an egg laying tray. One egg laying cavity is disposed between two adjacent center wall panels. The top cover is disposed at a top of each egg laying cavity, an egg laying tray is disposed in each egg laying cavity and located on a side away from the top cover, and the egg laying tray is detachably assembled with the center wall panel. The egg laying box further includes a first disassembling component that is detachably assembled on the center wall panel and used to fasten or separate the top cover to or from a top of the center wall panel. According to the above technical solution, because one top cover is correspondingly disposed at the top of each egg laying cavity, a top cover of an egg laying box with a plurality of egg laying cavities is not a whole block. By disposing the first disassembling component, the center wall panel can be fastened to or separated from the top cover. Therefore, the egg laying box can be easily packaged and transported.

### TECHNICAL FIELD

The utility model relates to the technical field of culture tools, and in particular, to an egg laying box.

### BACKGROUND

An egg laying nest, a product for production of breeding poultry, is referred to as an egg laying box, and is called “nest” in English. The egg laying nest is a chicken nest (duck nest, goose nest, or the like) specially designed for users to raise chickens, and is convenient for breeders to collect eggs (duck eggs, goose eggs, or the like). The egg laying nest is an essential product for production of breeding poultry for the future development of poultry industry.

At present, there are two types of egg laying boxes, namely, an open type and a self-closing type. The former is appropriate to general laying birds. The latter is dedicated to breeding flocks requiring individual records. There are two kinds of egg laying boxes, namely, a divided type and an undivided type. A dimension of each grid of the egg laying box is: width 30-35 cm, depth 35-40 cm, and height: 30-40 cm. A divided egg laying box usually includes a top cover, a plurality of center walls, and a plurality of chassis. The plurality of center walls are disposed at intervals and parallel to each other, tops of the center walls and the top cover are fastened with a screw, and an egg laying grid is formed between two adjacent center walls. One chassis is disposed at a bottom of each egg laying grid, and bottoms of the two adjacent center walls are respectively connected to two ends of the chassis The top cover is a whole block and cannot be detached, which increases difficulty of packaging and is not convenient for transport. Therefore, the top cover needs to be improved.

### SUMMARY

The present disclosure aims to provide, for disadvantages in the prior art, an egg laying box. Because a top cover is correspondingly disposed at a top of each egg laying cavity, the top cover of the egg laying box with a plurality of egg laying cavities is not a whole block. By disposing a first disassembling component, a center wall panel can be fastened to or separated from the top cover. Therefore, the egg laying box can be easily packaged and transported.

In order to achieve the above objective, the utility model adopts the following technical solution: An egg laying box includes a box body, and at least one egg laying cavity is disposed on the box body. The box body includes: a center wall panel, a top cover, and an egg laying tray. One egg laying cavity is disposed between two adjacent center wall panels. The top cover is disposed at a top of each egg laying cavity, the egg laying tray is disposed in each egg laying cavity and located on a side away from the top cover, and the egg laying tray is detachably assembled with the center wall panel. The egg laying box further includes a first disassembling component that is detachably assembled on the center wall panel and used to fasten or separate the top cover to or from a top of the center wall panel.

A fixing plate portion is disposed on a side, close to the center wall panel, at a bottom of the top cover. A plurality of fixing holes are oppositely disposed on the center wall panel and the fixing plate portion. The first disassembling component includes a first knob screw of which one end sequentially penetrates through the fixing holes on the center wall panel and the fixing plate portion. A first knob nut that is connected to a screw portion of the first knob screw in a threaded manner, where when the first knob screw is connected to the first knob nut, the center wall panel and the fixing plate portion are located between a limiting head of the first knob screw and the first knob nut.

A positioning plate portion is disposed on a side wall of the bottom of the top cover, and the positioning plate portion is located at the top of the center wall panel.

A positioning bump is disposed on a side, away from the top cover, of the center wall panel, and a positioning hole in which the positioning bump is inserted is disposed at an edge of an opening of the egg laying tray.

A plurality of threaded holes are disposed at an edge of an opening of the egg laying box, a plurality of first grooves are disposed at intervals on both sides of the center wall panel. A through hole that is connected to the threaded hole is disposed on a lower wall of the first groove on the center wall panel, and a screw is fastened to the threaded hole through the through hole.

Each center wall panel includes: a first panel body of which bottom is fastened to the egg laying tray through the screw, where the plurality of first grooves are disposed on both sides of the first panel body; a second panel body that is disposed on a top of the first panel body, where a plurality of second grooves are disposed on both sides of the second panel body, and through holes that are connected to each other are disposed on top walls of the first grooves and bottom walls of the second grooves; and a second disassembling component of which one part penetrates through the through holes on the first panel body and the second panel body and used to fasten or separate the first panel body to or from the second panel body.

A second knob screw of which one end sequentially penetrates through the through holes on the first panel body and the second panel body; and a second knob nut that is connected to a screw portion of the second knob screw in the threaded manner.

A part of the egg laying tray is located inside the egg laying cavity and the other part of the egg laying tray extends outside the egg laying cavity, a bottom surface of the egg laying tray is in an inclined shape, a placing groove is opened on a top of the egg laying tray, and a stepping cover is disposed on the top of the egg laying tray and located outside the egg laying cavity.

The stepping cover is hinged with the egg laying box, and a plurality of ventilation holes are disposed at a bottom of the placing groove and located below the stepping cover.

From the above technical solution, the utility model has the following beneficial effects: The egg laying box includes the box body, and the at least one egg laying cavity is disposed on the box body. The box body includes: the center wall panel, the top cover, and the egg laying tray. The one egg laying cavity is disposed between the two adjacent center wall panels. The top cover is disposed at the top of each egg laying cavity, the egg laying tray is disposed in each egg laying cavity and located on the side away from the top cover, and the egg laying tray is detachably assembled with the center wall panel. The egg laying box further includes the first disassembling component. The first disassembling component is detachably assembled on the center wall panel and used to fasten or separate the top cover to or from the top of the center wall panel. Because one top cover is correspondingly disposed at the top of each egg laying cavity, a top cover of an egg laying box with a plurality of egg laying cavities is not a whole block. By disposing the first disassembling component, the center wall panel can be fastened to or separated from the top cover. Therefore, the egg laying box can be easily packaged and transported.

### BRIEF DESCRIPTION OF THE DRAWINGS

To describe the technical solutions in embodiments of the utility model or in the prior art more clearly, the following briefly introduces the accompanying drawings required for describing the embodiment or the prior art. Apparently, the accompanying drawings in the following description show merely some embodiments of the utility model, and a person of ordinary skill in the art may still derive other drawings from these accompanying drawings without creative efforts.

FIG. 1 is a schematic diagram of a structure of an egg laying box with one egg laying cavity;

FIG. 2 is a schematic diagram of a structure of an egg laying box with one egg laying cavity in another direction;

FIG. 3 is a schematic exploded view of an egg laying box with one egg laying cavity;

FIG. 4 is a schematic exploded vie of an egg laying box with one egg laying cavity in another direction;

FIG. 5 is a schematic diagram of a structure of an egg laying box with two egg laying cavities;

FIG. 6 is a schematic exploded view of an egg laying box with two egg laying cavities;

FIG. 7 is a schematic diagram of a structure of an egg laying box with four egg laying cavities;

FIG. 8 is a schematic exploded view of an egg laying box with four egg laying cavities;

FIG. 9 is a schematic diagram of a structure of a stepping cover; and

FIG. 10 is a schematic diagram of a structure of an egg laying tray without a stepping cover.

Reference numerals: a. egg laying cavity; 1. center wall panel; 2. top cover; 3. egg laying tray; 4. first disassembling component; 21. fixing plate portion; 22. positioning plate portion; b. hanging hole; c. placing groove; 31. stepping cover; d. ventilation hole; 32. rotating shaft; e. rotating hole; 311. operation portion; f. handle hole; 41. first knob screw; 42. first knob nut; g. fixing hole; 411. limiting head; 11. positioning bump; h. positioning hole; 33. inserting portion; 34. limiting plate; i. first groove; j. through hole; k. threaded hole; 12. first panel body; 13. second panel body; 36. second disassembling component; m. second groove; 361. second knob screw; 362. second knob nut; 121. first positioning portion; 131. second positioning portion; and 5. screw.

### DETAILED DESCRIPTION OF THE EMBODIMENTS

The following further describes the utility model with reference to the accompanying drawings.

This specific example is only an explanation of the utility model, but it does not limit the utility model. Those skilled in the art can make modifications without creative contribution to the present example as needed after reading this specification, but these modifications are protected by patent law as long as they fall within the scope of the utility model.

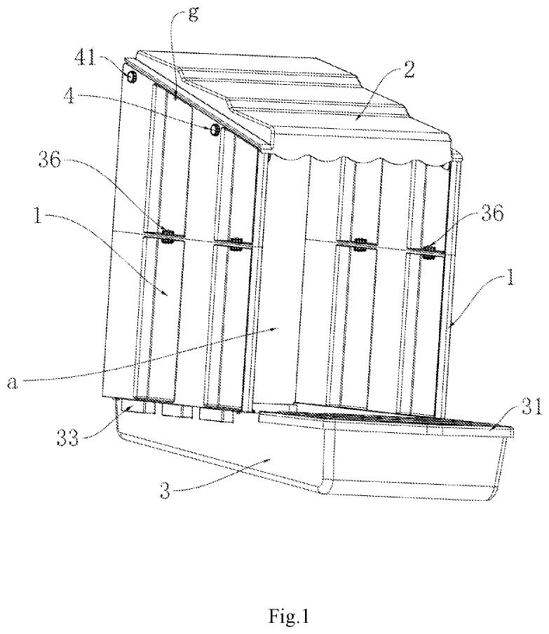

An embodiment relates to an egg laying box. As shown in FIG. 1 to FIG. 4, the egg laying box includes a box body, and at least one egg laying cavity a is disposed on the box body. The box body is made of a hard material such as plastic, alloy, or wood. Openings are disposed on a front side and a rear side of the egg laying cavity a. The box body includes: a center wall panel 1, a top cover 2, and an egg laying tray 3. One egg laying cavity a is disposed between two adjacent center wall panels 1. The top cover 2 is disposed at a top of each egg laying cavity a, the egg laying tray 3 is disposed in each egg laying cavity a and located on a side away from the top cover 2, the egg laying tray 3 is detachably assembled with the center wall panel 1. The egg laying box further includes a first disassembling component 4. The first disassembling component 4 is detachably assembled on the center wall panel 1 and used to fasten or separate the top cover 2 to or from the top of the center wall panel 1. Because one top cover 2 is correspondingly disposed at the top of each egg laying cavity a, a top cover 2 of the egg laying box with a plurality of egg laying cavities a is not a whole block. By disposing the first disassembling component 4, the center wall panel 1 can be fastened to or separated from the top cover. Therefore, the egg laying box can be easily packaged and transported.

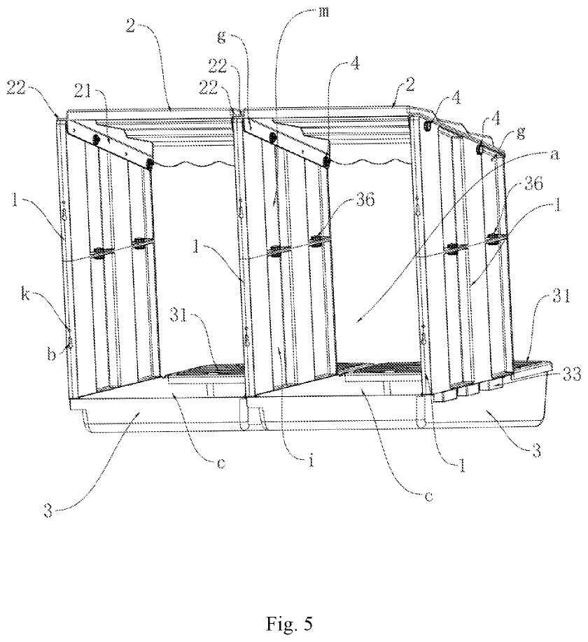

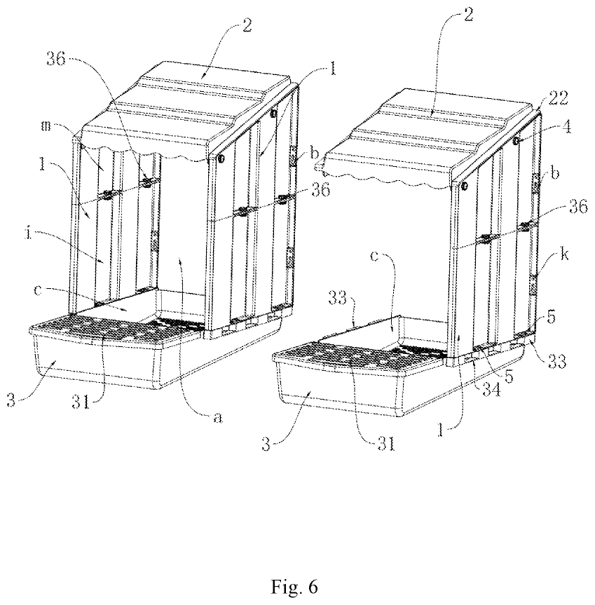

In this embodiment, as shown in FIG. 5 and FIG. 6, a plurality of hanging holes b and/or threaded holes k are disposed on a rear side wall of the center wall panel 1. Therefore, a user can hang the egg laying box on an external assembly, or place the egg laying box on the ground. For example, a nail, a bolt, or the like is mounted on a wall at an appropriate height. A width of a bottom of the hanging hole b is large and a width of a top of the hanging hole b is small. After a head of the bolt or the nail is inserted into the bottom of the hanging hole b, the egg laying box is moved downward, to hang and fasten the egg laying box.

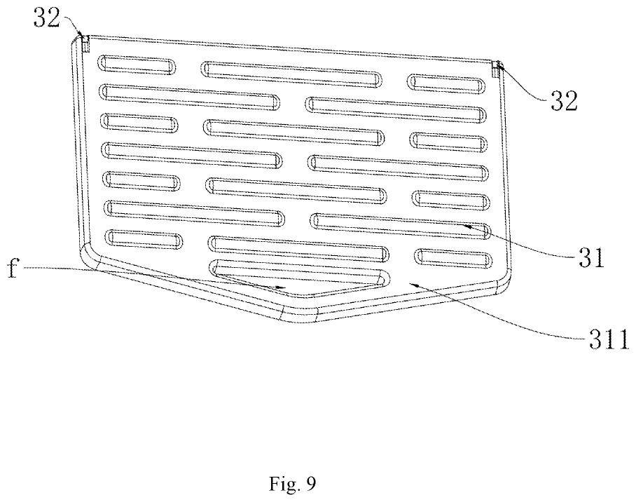

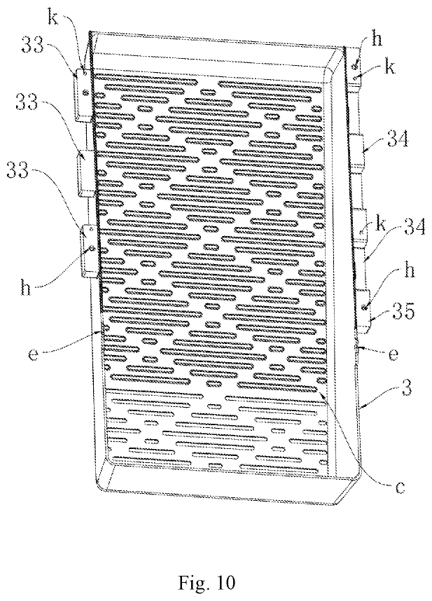

Optionally, a part of the egg laying tray 3 is located inside the egg laying cavity a and the other part of the egg laying tray 3 extends outside the egg laying cavity a, a bottom surface of the egg laying tray 3 is in an inclined shape, a placing groove c is opened on a top of the egg laying tray 3, and a bottom surface in the placing groove c is in an inclined shape. Therefore, an egg may roll to a lower end. A stepping cover 31 is disposed on the top of the egg laying tray 3 and located outside the egg laying cavity a, to avoid poultry trampling the egg. Preferably, to facilitate the user to fetch eggs, as shown in FIG. 9 and FIG. 10, the stepping cover 31 is hinged with the egg laying box, and a plurality of ventilation holes d are disposed at a bottom of the placing groove c and located below the stepping cover 31. A rotating shaft 32 is disposed on a side, close to the center wall panel 1, of the stepping cover 31. A rotating hole e that is used to assemble the rotating shaft 32 in a rotation manner is opened on a side, located at an edge of an opening of the placing groove c and close to the center wall panel 1, of the egg laying tray 3. It should be noted that a width of the stepping cover 31 is larger than or equal to a width of the egg laying tray 3. An operation portion 311 is integrally disposed on a side, away from the center wall panel 1, of the stepping cover 31. A handle hole f is opened on the operation section 311 for a user to open the stepping cover 31 and take eggs.

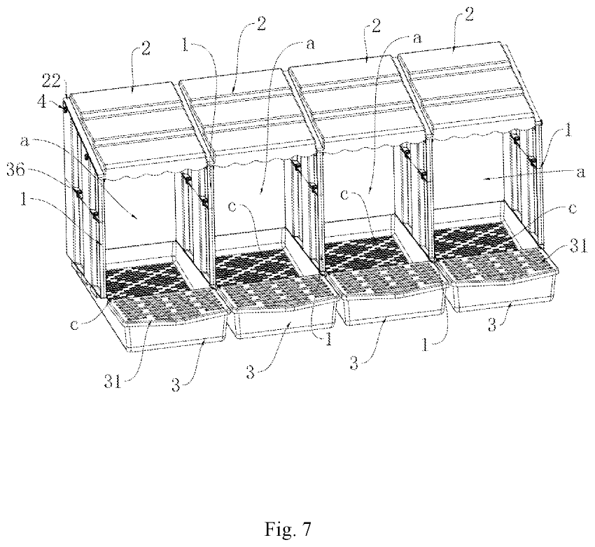

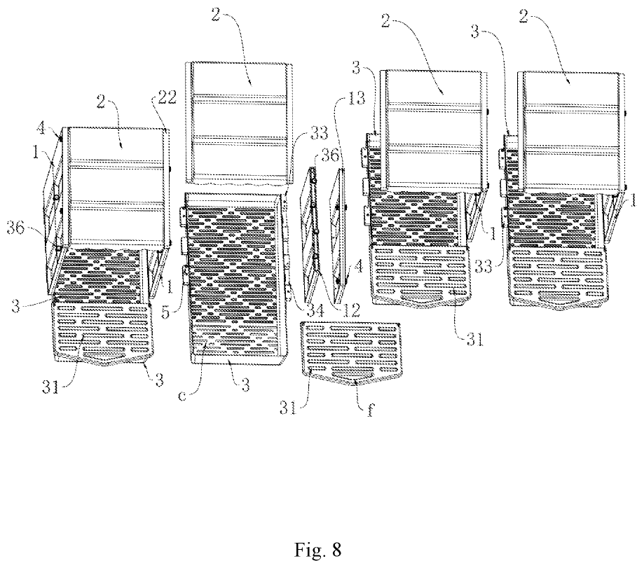

Preferably, because the cover plate and the center wall panel 1 may be quickly disassembled or assembled, the egg laying box can be easily packaged and transported, alternatively, the user can arrange the egg laying box base on a combination of poultry and a place of origin, to prevent space from being occupied by some unused egg laying cavities because of insufficient quantity of poultry, and resolve a problem that a quantity of egg laying cavities a of the egg laying box cannot be reduced. As shown in FIG. 1 to FIG. 8, a fixing plate portion 21 is disposed on a side, close to the center wall panel 1, at a bottom of the top cover 2. A plurality of fixing holes g are oppositely disposed on the center wall panel 1 and the fixing plate portion 21. The first disassembling component 4 includes a first knob screw 41 and a first knob nut 42. One end of the first knob screw 41 sequentially penetrates through the fixing holes g on the center wall panel 1 and the fixing plate portion 21. There are a plurality of fixing holes g on the center wall panel 1 and the fixing holes g on the fixing plate. The fixing holes g of the center wall panel 1 and the fixing plate are oppositely disposed in a one-to-one manner. The first knob nut 42 is connected to a screw portion of the first knob screw 41 in a threaded manner. When the first knob screw 41 is connected to the first knob nut 42, the center wall panel 1 and the fixing plate portion 21 are located between a limiting head 411 of the first knob screw 41 and the first knob nut 42. Dimensions of the limiting head 411 of the first knob nut 42 and the first knob screw 41 are larger than a diameter of the fixing hole g.

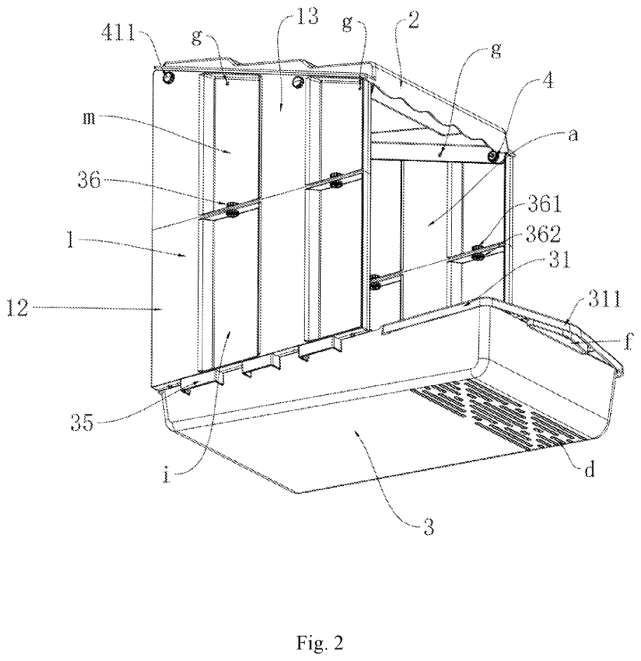

It should be noted that, as shown in FIG. 1, FIG. 2, and FIG. 5 to FIG. 8. There may be one, two, or more egg laying cavities a on the egg laying box. When the egg laying box is provided with one egg laying cavity a, the egg laying box includes one top cover 2, two center wall panels 1, one egg laying tray 3, and a plurality of first disassembling components 4. When the egg laying box is provided with two egg laying cavities a, the egg laying box includes two top covers 2, three center wall panels 1, two egg laying trays 3, and a plurality of first disassembling components 4. When the number of poultry of the user is reduced and the user needs to save space, the user can remove the one top cover 2, one center wall panel 1, and one egg laying tray 3 from the egg laying box through the first disassembling component 4. Therefore, the egg laying box has only one egg laying cavity a, so that the user can randomly combine the quantity of egg laying cavities a of the egg laying box based on the number of poultry. Optionally, a positioning plate portion 22 is disposed on a side wall of the bottom of the top cover 2, and the positioning plate portion 22 is located at the top of the center wall panel 1. In this embodiment, the positioning plate portion 22 is assembled and positioned between the top cover 2 and the center wall panel 1. Cross sections of a combination of the positioning plate portion 22 and the fixing plate portion 21 is in ┐ or ┌ shape.

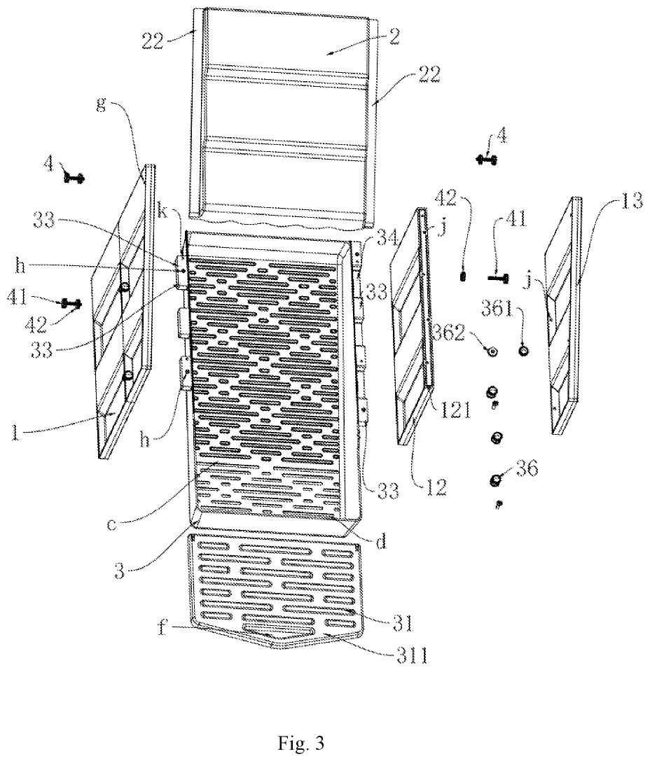

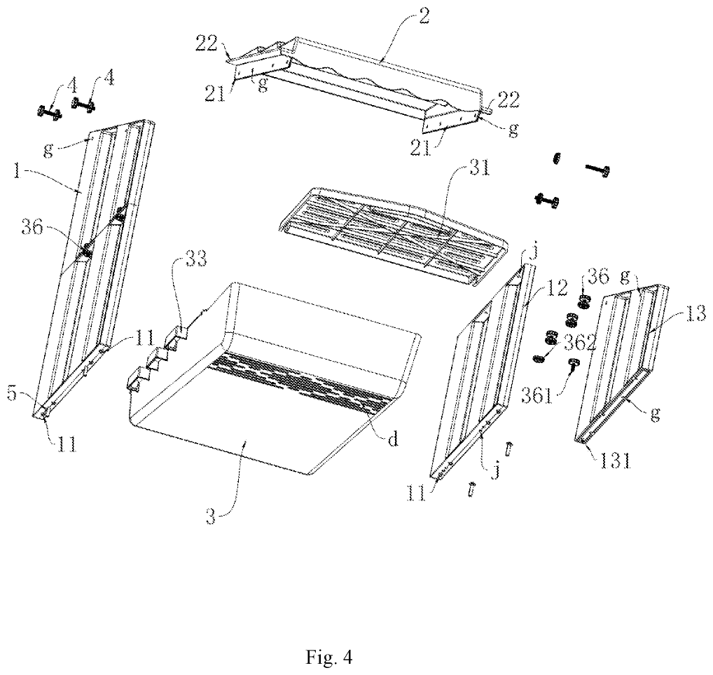

Optionally, to facilitate assembly of the center wall panel 1 and the egg laying tray 3, as shown in FIG. 3 and FIG. 4, a positioning bump 11 is disposed on a side, away from the top cover 2, of the center wall panel 1, and a positioning hole h in which the positioning bump 11 is inserted is disposed at an edge of an opening of the egg laying tray 3. Preferably, to facilitate assembly or disassembly of the egg laying tray 3 and the center wall panel 1, and facilitate usage, packaging, or transport of the egg laying box, a plurality of threaded holes k are opened at an edge of an opening of the egg laying box. In this embodiment, the threaded hole k and the positioning hole h are disposed on two opposite side walls of the egg laying tray 3. A plurality of inserting portions 33 are protruded outward from tops of two sides of the egg laying tray 3, and the inserting portions 33 on the two opposite sides of the egg laying tray 3 are staggered in a one-to-one manner. The inserting portions 33 on each side are disposed in a straight line, and the threaded hole k and the positioning hole h are located at tops of the inserting portions 33. A limiting plate 34 is disposed between two adjacent inserting portions 33 on one side wall of the egg laying tray 3, and two ends of the limiting plate 34 are respectively connected to bottom surfaces of the two adjacent inserting portions 33. A plurality of first grooves i are disposed at intervals on both sides of the center wall panel 1. A through hole j that is connected to the threaded hole k is disposed on a lower wall of the first groove i on the center wall panel 1, and a screw 5 is fastened to the threaded hole k through the through hole j. In some embodiments, the screw 5 is a cross screwdriver 5 slot or a straight screwdriver 5. In some embodiments, to assemble or disassemble the center wall panel 1 and the egg laying tray 3 without an external tool such as a screw 5, the screw 5 is a knob screw.

Optionally, as shown in FIG. 2 to FIG. 4, to further facilitate the packaging and transport of the egg laying box, reduce space occupied by the center wall panel 1 during packing, each center wall panel 1 includes a first panel body 12, a second panel body 13, and a second disassembling component 36. A bottom of the first panel body 12 is fastened to the egg laying tray 3 with the screw 5, and the plurality of first grooves i are respectively located on both sides of the first panel body 12. The second panel body 13 is disposed on a top of the first panel body 12. A plurality of second grooves m are disposed on both sides of the second panel body 13, and through holes j that are connected to each other are disposed on top walls of the first grooves i and bottom walls of the second grooves m. One part of the second disassembling component 36 penetrates through the through holes j on the first panel body 12 and the second panel body 13 and is used to fasten or separate the first panel body 12 to or from the second panel body 13. In this embodiment, the opening on the front side of the egg laying cavity a of the egg laying box is short, and the opening on the rear side of the egg laying cavity a is high. Preferably, to enable functions of second disassembling component 36, the second disassembling component 36 includes a second knob screw 361 and a second knob nut 362. One end of the second knob screw 361 sequentially penetrates through the through holes j on the first panel body 12 and the second panel body 13. The second knob nut 362 is connected to a screw portion of the second knob screw 361 in the threaded manner. In some embodiments, to easily position between the first panel body 12 and the second panel body 13, a first positioning portion 121 is disposed at the top of the first panel body 12, and a second positioning portion 131 that may be inserted with the first positioning portion 121 is disposed at a bottom of the second panel body 13. The first positioning portion 121 is a positioning slot or a positioning insert block. The above embodiments are only intended to describe the technical solutions of the utility model, rather than to limit the utility model. Those of ordinary skill in the art may make other modifications or equivalent replacements to the technical solutions of the utility model without departing from the spirit and scope of the technical solutions of the utility model, but such modifications or equivalent replacements should fall within the scope defined by the claims of the utility model.

1. An egg laying box, comprising a box body, wherein at least one egg laying cavity (a) is disposed on the box body, the box body comprises: a center wall panel (1), a top cover (2), and an egg laying tray (3), one egg laying cavity (a) is disposed between two adjacent center wall panels (1), the top cover (2) is disposed at a top of each egg laying cavity (a), the egg laying tray (3) is disposed in each egg laying cavity (a) and located on a side away from the top cover (2), the egg laying tray (3) is detachably assembled with the center wall panel (1), and the egg laying box further comprises: a first disassembling component (4) that is detachably assembled on the center wall panel (1) and used to fasten or separate the top cover (2) to or from a top of the center wall panel (1).

2. The egg laying box according to claim 1, wherein a fixing plate portion (21) is disposed on a side, close to the center wall panel (1), at a bottom of the top cover (2), a plurality of fixing holes (g) are oppositely disposed on the center wall panel (1) and the fixing plate portion (21), the first disassembling component (4) comprises a first knob screw (41) of which one end sequentially penetrates through the fixing holes (g) on the center wall panel (1) and the fixing plate portion (21); and a first knob nut (42) that is connected to a screw portion of the first knob screw (41) in a threaded manner, wherein when the first knob screw (41) is connected to the first knob nut (42), the center wall panel (1) and the fixing plate portion (21) are located between a limiting head (411) of the first knob screw (41) and the first knob nut (42).

3. The egg laying box according to claim 1, wherein a positioning plate portion (22) is disposed on a side wall of the bottom of the top cover (2), and the positioning plate portion (22) is located at the top of the center wall panel (1).

4. The egg laying box according to claim 1, wherein a positioning bump (11) is disposed on a side, away from the top cover (2), of the center wall panel (1), and a positioning hole (h) in which the positioning bump (11) is inserted is disposed at an edge of an opening of the egg laying tray (3).

5. The egg laying box according to claim 1, wherein a plurality of threaded holes (k) are disposed at an edge of an opening of the egg laying box, a plurality of first grooves (i) are disposed at intervals on both sides of the center wall panel (1), a through hole (j) that is connected to the threaded hole (k) is disposed on a lower wall of the first groove (i) on the center wall panel (1), and a screw (5) is fastened to the threaded hole (k) through the through hole (j).

6. The egg laying box according to claim 5, wherein each center wall panel (1) comprises: a first panel body (12) of which bottom is fastened to the egg laying tray (3) through the screw (5), wherein the plurality of first grooves (i) are disposed on both sides of the first panel body (12); a second panel body (13) that is disposed on a top of the first panel body (12), wherein a plurality of second grooves (m) are disposed on both sides of the second panel body (13), and through holes (j) that are connected to each other are disposed on top walls of the first grooves (i) and bottom walls of the second grooves (m); and a second disassembling component (36) of which one part penetrates through the through holes (j) on the first panel body (12) and the second panel body (13) and used to fasten or separate the first panel body (12) to or from the second panel body (13).

7. The egg laying box according to claim 6, wherein the second disassembling component (36) comprises: a second knob screw (361) of which one end sequentially penetrates through the through holes (j) on the first panel body (12) and the second panel body (13); and a second knob nut (362) that is connected to a screw portion of the second knob screw (361) in the threaded manner.

8. The egg laying box according to claim 1, wherein a part of the egg laying tray (3) is located inside the egg laying cavity (a) and the other part of the egg laying tray (3) extends outside the egg laying cavity (a), a bottom surface of the egg laying tray (3) is in an inclined shape, a placing groove (c) is opened on a top of the egg laying tray (3), and a stepping cover (31) is disposed on the top of the egg laying tray (3) and located outside the egg laying cavity (a).

9. The egg laying box according to claim 8, wherein the stepping cover (31) is hinged with the egg laying box, and a plurality of ventilation holes (d) are disposed at a bottom of the placing groove (c) and located below the stepping cover (31).
